(19) United States
(12) Patent Application Publication
(10) Pub. No.: US 2019/0087165 A1
(43) Pub. Date: Mar. 21, 2019

(54) SYSTEM AND METHOD FOR IMPLEMENTING DYNAMIC STRATEGIES OF COMPUTING INFRASTRUCTURE USING A DOMAIN-SPECIFIC LANGUAGE FOR CLOUD SERVICES INFRASTRUCTURE

(71) Applicant: FUGUE, INC., Frederick, MD (US)

(72) Inventor: Josha STELLA, Shepherdstown, WV (US)

(73) Assignee: FUGUE, INC., Frederick, MD (US)

(21) Appl. No.: 16/137,088

(22) Filed: Sep. 20, 2018

Related U.S. Application Data
(60) Provisional application No. 62/560,976, filed on Sep. 20, 2017.

(51) Int. Cl. G06F 8/51; G06F 8/41; G06F 15/18

(52) U.S. Cl. CPC G06F 8/51; G06F 8/44; G06F 8/31; G06F 15/18; G06F 8/48

(57) ABSTRACT

A system and method for providing and executing a domain-specific programming language for cloud services infrastructure is provided. The system may be used to integrate references to external entities, such as cloud service compute instances, directly into a domain-specific programming language, allowing developers to easily integrate cloud services directly using the domain-specific programming language. The domain-specific programming language may also allow users to declare strategies for a given computing system rather than specific instances of computing infrastructure. The strategies can be resolved by an artificial intelligence engine to determine an optimal computing instance solution to the user declared strategy. The determined solution from the artificial intelligence engine can be used to generate a computing system on a cloud service provider account.

### CROSS-REFERENCE TO RELATED APPLICATION

This application claims the benefit of U.S. Provisional Application No. 62/560,976 filed Sep. 20, 2017, the entire contents of which are incorporated herein by reference.

### FIELD OF THE DISCLOSURE

The invention relates to a system and method for implementing dynamic strategies of computing infrastructure using a domain-specific language for cloud services infrastructure.

### BACKGROUND OF THE INVENTION

A number of cloud service providers sell various cloud services to execute compute instances on behalf of their customers. For example, AMAZON sells its AMAZON WEB SERVICES (AWS) service, GOOGLE sells its GOOGLE APP ENGINE service, and others sell similar services. In exchange for a fee, AMAZON, GOOGLE, and other cloud service providers provide the use of their servers and other infrastructure to customers for a limited time in the form of a cloud service instance. The fee may vary depending on a time/date that the cloud service instance is to be run, a performance of the cloud service instance (e.g., throughput, latency, etc.), whether the offered cloud service instance is a spot instance or a standard instance, and/or other attributes.

Integrating use of cloud services into an organization's processes can be difficult. Conventionally, users can manually enter an input into a cloud services command line interface (CLI) or graphical user interface (GUI). Making the process of creating cloud infrastructure more user friendly can be achieved through the use of specialized programs in conventional programming languages that attempt to instantiate, monitor, and update cloud instances. However, the use of conventional programming languages to create computing infrastructure in a cloud environment can prove to be cumbersome and complex.

Providing a user with a domain-specific programming language, in which the programming language can be configured to allow the user to easily declare the desired infrastructure, can aid in decreasing the burden associated with using a programming language to build computing infrastructure on a cloud. To further aid the user in developing computing infrastructure using the domain-specific programming language described above, the domain-specific language can allow the user to declare abstract strategies for a computing system to be implemented by the cloud. In contrast to static resolution, in which the user provides a precise declaration of their desired computing infrastructure, a user can instead declare a broad strategy in the domain specific language, and the strategy can be resolved dynamically by an artificial intelligence engine.

### SUMMARY OF THE DISCLOSURE

Accordingly, the following disclosure is related to a domain specific language for cloud services infrastructure which allows for a user to create a computing environment using a user-friendly syntax that can be converted into code that is readable by a cloud computing services provider and a method for visualizing the computing environment that the user is building using the domain-specific programming language code. .

In one example, the user-generated code contains declarations of computing infrastructure. The declarations can be checked against a state information service that can determine if the declared infrastructure exists on the cloud service provider, and if the declared infrastructure is in scope with what is provided by the cloud service provider.

In another example, the user-generated code contains declarations of computing infrastructure strategies. The computing infrastructure strategies can be resolved by an artificial intelligence engine that can convert the user-defined strategies into static declarations of computing infrastructure that can be used by a cloud operating system to build and maintain a computing system on a cloud service provider. In addition to the user-declared strategies, the artificial intelligence engine can also use external data such as information about the load and speed of the computing system already in existence or to be created, in order to resolve the user-declared strategies into static declarations of computing infrastructure.

In one or more examples, after creating the computing infrastructure with the user-defined strategies resolved by the AI engine, the strategies can be periodically checked to determine if the computing infrastructure associated with the strategies need to be modified in light of changing computing infrastructure requirements or conditions.

### BRIEF DESCRIPTION OF THE DRAWINGS

FIG. 1 illustrates a system of providing and executing a domain-specific programming language for cloud services infrastructure, according to an implementation of the invention.

FIG. 2 illustrates a process flow diagram of various system components for providing and executing a domain-specific programming language for cloud services infrastructure, according to examples of the disclosure.

FIG. 3 illustrates an exemplary runtime environment of a compiled domain specific programming language for cloud services infrastructure, according to examples of the disclosure.

FIG. 4 illustrates a process of compiling a domain-specific programming language for cloud services infrastructure, according to examples of the disclosure.

FIG. 5 illustrates an exemplary explain process according to examples of the disclosure.

FIG. 6 illustrates a process of executing a domain-specific programming language for cloud services infrastructure, according to examples of the disclosure.

FIG. 7 illustrates an exemplary process for resolving user-declared strategies in a domain-specific programming language by an artificial intelligence engine so as determine and create computing infrastructure that fulfills the strategy according to examples of the disclosure.

FIG. 8 illustrates an exemplary process of modifying computing infrastructure implemented on a cloud service provider account in response to changing resolutions of user-declared strategies in a domain-specific programming language according to examples of the disclosure.

FIG. 9 illustrates an example of a computing device in according to examples of the disclosure.

### DETAILED DESCRIPTION OF THE INVENTION

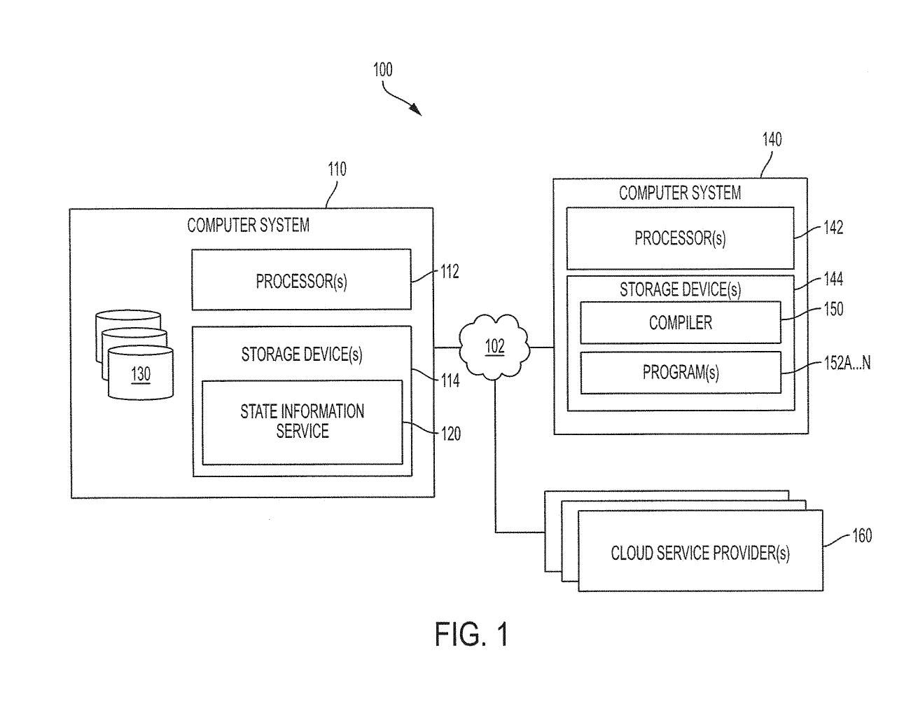

FIG. 1 illustrates a system 100 of providing and executing a domain-specific programming language for cloud services infrastructure (hereinafter, “domain-specific programming language” for convenience), according to an implementation of the invention. The system may be used to integrate references to external entities, such as cloud service compute instances, directly into a domain-specific programming language, allowing developers to easily integrate cloud services directly using the domain-specific programming language.

For illustration and not limitation, the external entities will be described as cloud compute instances (e.g., compute instances executed at a computer operated by a cloud service provider) that may be referenced directly within the domain-specific programming language described herein. However, other external entities (e.g., external to a given memory of a computer device that executes code that uses the domain-specific programming language described herein) may be used as well. As an example, the external entities can include DNS entries, binary objects, shared queues, database tables, etc.

The system may be used to facilitate checking against the type and state of an external entity in the language itself, including at authoring, build and run times. Furthermore, the system may facilitate compilation, type checking and debugging while authoring programs against external entities as opposed to requiring testing to be performed to find errors and bugs.

Language Primitives that are References to Infrastructure or Other External Entities

Typically, in a programming language, a variable may be resolved to an address in memory at runtime. For example, if one were to define my-thing=123456, this would put the value 123456 to a location in memory. After definition, any code using my-thing would either get a reference to that memory address or would receive a copy of the value.

Using the domain-specific programming language described herein, references to external entities (not in memory) as variables may be used. For example, by defining mything=this-instance, this-instance would be resolved to a URL or other identifier of a running virtual computer, as opposed to an address in memory. This allows for checking against the type and state of an external entity in the language itself, including at authoring, build and run times. The reference may be set by another program, manual configuration (e.g., at compile time), and/or other processes. By using language primitives that are references to cloud services infrastructure, the system facilitates checking, at compile and debug time, for the legitimacy of the reference, and to have a valid reference at runtime. Computing infrastructure can refer to components within a computing system that are being provided by a cloud service rather than having to use physical on-site devices. For instance computing infrastructure can refer to computing devices such as virtual machines, load balancers, virtual networks, data storage services, domain name services, disk imagers, containers, clusters, and lambda instructions. These examples are not meant to be limiting, and are only provided as examples. The domain-specific programming language further facilitates compilation, type checking and debugging while authoring programs against external entities as opposed to requiring testing to be performed to find errors and bugs.

### Lexical Scoping That Maps to Abstractions of External Entities

In typical programming languages, lexical scoping is a way to organize pieces of code such that names can be re-used and also to allow for segmentation and encapsulation of elements of the program. For example, a private field in an Object-Oriented language prevents direct access to that data from outside the instance of the Class in which it is defined.

Using the domain-specific programming language described herein, lexical scoping may be mapped onto collections of entities that aren't a native part of the language. For example, a compute instance may be defined using the reference to external entity method described above: my-thing =this-instance, where this instance is a pointer to an actual entity in the runtime environment.

Using external entity lexical scoping, the system may make this-instance a child of this venue, where this-venue may include an arbitrary collection of entities. If this-instance was not public to the scope of the calling code, the compiler would return an error when directly referencing. This may occur when, for example, the scope of a variable was limited to a particular set of entities. The external entity may be associated with a single cloud service provider or different cloud service providers, the identification of which may be associated with a given variable or reference.

### Externalizing the Language Runtime State Information to a Service

In order to facilitate these and other benefits, the system may maintain state information of all references and shared variables across program boundaries. The system may make the state information accessible via a state information service that understands the language features of the domain-specific programming language.

At compile time, the compiled code can be processed by an interpreter module of the run-time environment (explained in detail below) that may query the state information service to identify a variable in scope to the use in the language in order to determine if it exists, and, if so, whether it is in scope to reference. The state information service may also deliver details on how the entity may be used, such as available functions or operations.

The state information service may keep detailed version information on the state of the variable. For example, if user A creates an entity via compiling and running a program, a corresponding variable may appear in the state information service, along with a serial number (or other version information) set to 1. In some examples, the corresponding variable can be a unique hash derived from the computing infrastructure's instance in the program. During the normal operations of the entity, its state changes (e.g., to another Internet Protocol address). A second program that initiates the change may update the table with the new IP address, and may increment the serial number to 2. When a third program references the entity, and has a version 1 understanding of the state, it sees that the new serial number is 2 and may query the state information service for the latest version.

The state information may be made generic and scoped across all the entities the organization wishes to have available. In this way, multiple users across many parts of an organization may interoperate with the products of their peers in other teams dynamically.

Other uses of system 100 are described herein and still others will be apparent to those having skill in the art. Having described a high level overview of some of the system functions, attention will now be turned to various system components that facilitate these and other functions.

The above infrastructure primitives and the lexical scoping applied to them, as discussed above, can be used to create functions that can yield patterns of infrastructure based on certain arguments inputted into those functions. The code example provided below, is an example of an enumeration type:

Type IcmpDescription:
   |Ping
   |DestinationUnreachable
   |RedirectMessage

The code example provided below, is an example of a data structure type that can define the properties of an “icmp.” In the example below, the icmp type has the property values “type” and “code” and these properties are expressed as integers.

Type Icmp:
   |type: INT
   |code: INT

The code example below, illustrates an example function using the domain specific language. The example code below taken a infrastrucre description and evaluates to an icmp (machine data).

Icmp fromDescription(IcmpDescription icmp):
Case icmp of
         |ping {code: 0, type: 0}
         |DestinationUnreachable {code: 0, type: 3}
         |Redirect Message {code: 0, type: 5}

The above functions can be evaluated at compile time by the explain function described in further detail below.

### Exemplary System Architecture

System 100 may include a computer system 110, a computer system 140, one or more cloud service providers 150, and/or other components.

### Computer System 110

Computer system 110 may include one or more processors 112 (also interchangeably referred to herein as processors 112, processor(s) 112, or processor 112 for convenience), one or more storage devices 114 (which may store a state information service 120, hereinafter SIS 120 for convenience), one or more entity state information databases 130, and/or other components. Processors 112 may be programmed by one or more computer program instructions. For example, processors 112 may be programmed by SIS 120 and/or other instructions.

### Computer System 140

Computer system(s) 140 may each include one or more processors 142 (also interchangeably referred to herein as processors 142, processor(s) 142, or processor 142 for convenience), one or more storage devices 144 (which may store a compiler 150A, one or more programs 152, and/or other instructions), and/or other components. Processors 142 may be programmed by one or more computer program instructions. For example, processors 142 may be programmed by compiler 150, programs 152, and/or other instructions.

### Cloud Service Providers 160

Cloud service providers 160 may include entities that sell various cloud services to execute compute instances on behalf of their customers. For example, AMAZON sells cloud service instances using its AMAZON WEB SERVICES (AWS) service, and GOOGLE sells cloud service instances using its GOOGLE APP ENGINE service. In other examples, cloud service providers can also include other specialized providers who provide non-compute services such as content delivery networks, domain name service, etc.

Cloud service providers 160 may also include entities that provide markets, or exchanges, for cloud services. For example, cloud service providers 160 may include markets that sell cloud service instances on behalf of others that actually provide the cloud service instances using their infrastructure. In this manner, system 100 may leverage exchanges that may sell various cloud service instances from different entities.

Although illustrated in FIG. 1 as a single component, computer system 110 and computer system 140 may each include a plurality of individual components (e.g., computer devices) each programmed with at least some of the functions described herein. In this manner, some components of computer system 110 and/or customer computer system 140 may perform some functions while other components may perform other functions, as would be appreciated. The one or more processors 112, 142 may each include one or more physical processors that are programmed by computer program instructions. The various instructions described herein are exemplary only. Other configurations and numbers of instructions may be used, so long as the processor(s) 112, 142 are programmed to perform the functions described herein.

Furthermore, it should be appreciated that although the various instructions are illustrated in FIG. 1 as being co-located within a single processing unit, in implementations in which processor(s) 112, 142 includes multiple processing units, one or more instructions may be executed remotely from the other instructions. In addition, at least some of the functions described herein with respect to processor(s) 112 may be performed by processor(s) 142, and vice versa. For example, processor(s) 112 may be programmed by compiler 150, programs 152, and/or execute a runtime environment for programs 152. Likewise, processor(s) 142 may be programmed with state information service 120.

The description of the functionality provided by the different instructions described herein is for illustrative purposes, and is not intended to be limiting, as any of instructions may provide more or less functionality than is described. For example, one or more of the instructions may be eliminated, and some or all of its functionality may be provided by other ones of the instructions. As another example, processor(s) 112 may be programmed by one or more additional instructions that may perform some or all of the functionality attributed herein to one of the instructions.

The various instructions described herein may be stored in a storage device 114, which may comprise random access memory (RAM), read only memory (ROM), and/or other memory. The storage device may store the computer program instructions (e.g., the aforementioned instructions) to be executed by processor 112 as well as data that may be manipulated by processor 112. The storage device may comprise floppy disks, hard disks, optical disks, tapes, or other storage media for storing computer-executable instructions and/or data.

The various components illustrated in FIG. 1 may be coupled to at least one other component via a network 102, which may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network. In FIG. 1 and other drawing Figures, different numbers of entities than depicted may be used. Furthermore, according to various implementations, the components described herein may be implemented in hardware and/or software that configure hardware.

The entity state information database 130 (and/or any other database) described herein may be, include, or interface to, for example, an Oracle™ relational database sold commercially by Oracle Corporation. The example database provided above is not meant to be limiting and the entity state information database 130 could include, or be interfaced to other databases, such as Informix™, DB2 (Database 2), Amazon DynamoDB™ or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may store a plurality of types of data and/or files and associated data or file descriptions, administrative information, or any other data.

### Exemplary System Processing Operations

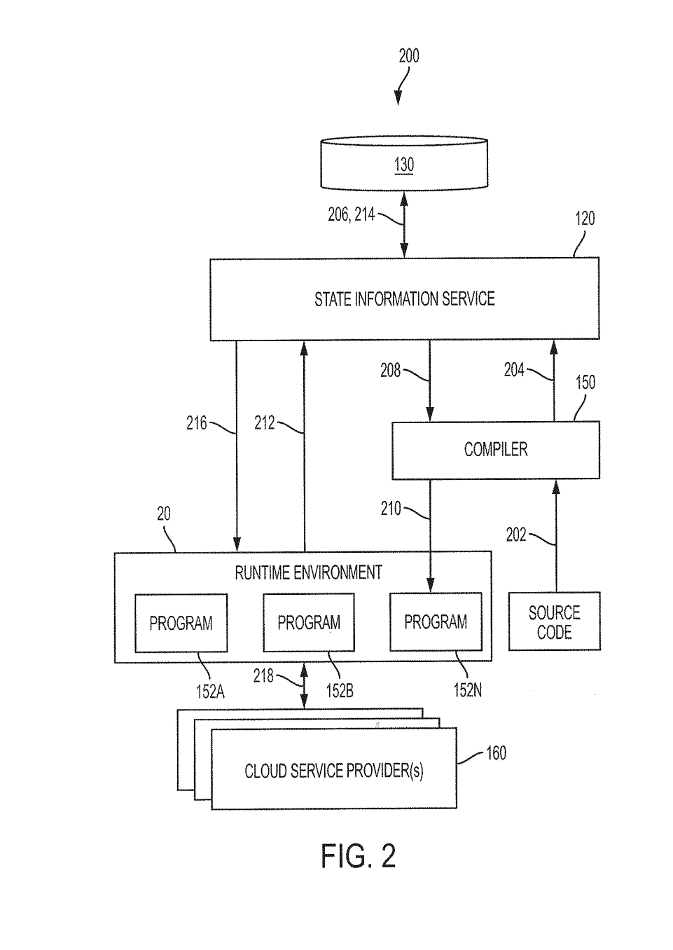

FIG. 2 depicts a process flow diagram 200 of various system components for providing and executing a domain-specific programming language for cloud services infrastructure, according to an implementation of the invention. The various processing operations and/or data flows depicted in FIG. 2 are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 202, source code in the domain-specific programming language for cloud services infrastructure may be received. For example, a developer may draft the source code to be received and compiled by compiler 150.

The compiled code generated by compiler 150 may be sent to the run-time environment 20, in which an explain action can be initiated (described further below) and a query can be sent to SIS 120 to identify a variable in scope to the use in the source code to determine whether the variable exists, and, if so, whether the variable is in scope to the reference.

In an operation 206, SIS 120 may query entity state information database 130 to obtain the state information for the variable and/or the reference.

SIS 120 may obtain and provide any relevant state information (which may indicate an existence of the variable, its scope, a reference to an external entity such as a compute instance provided by cloud service provider 150, how an entity may be used such as its available functions, etc.) to the other components in the run-time environment (or return NULL or other indication that the variable does not exist).

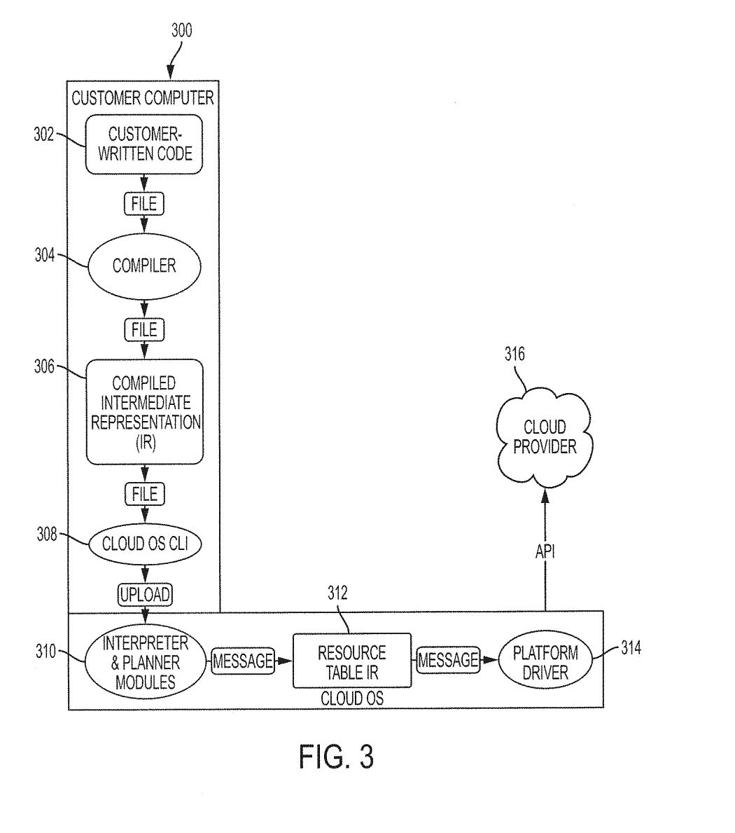

In an operation 210, compiler 150 may generate an executable program (hereinafter referred to as program 152A for convenience) if the variable exists and is in scope based on the state information. Program 152A may be placed run in runtime environment 20, along with other programs (152B, . . . , N) that have been compiled by compiler 150. The run-time environment is discussed in detail below with respect to FIG. 3.

In an operation 212, runtime environment 20 may execute program 152B. For example, program 152B may be called to run in runtime environment 20 by a human user, a process, and/or other user. Runtime environment 20 may query SIS 120 to identify a variable in scope to the use in the program 152B to determine whether the variable exists, and, if so, whether the variable is in scope to the reference. For example, runtime environment 20 may transmit the query via network 102 to SIS 120.

In an operation 214, SIS 120 may query entity state information database 130, as described with respect to operation 206.

In an operation 216, SIS 120 may obtain and provide any relevant state information to runtime environment 20, as described before with respect to operation 208. Runtime environment may cause an error (e.g., a runtime fault) to occur if a given variable is not in scope to the calling compiled code (program 152B). Otherwise, runtime environment 20 may obtain a current state of a given variable in program 152B at the time of execution so that any state changes related to a referenced entity (e.g., compute instance executing at a cloud service provider 160) may be accounted for during execution of program 152B.

In an exemplary operation of programs in runtime environment 20, a user may compile and execute program 152A, which may include a variable that references an entity and causes the entity to be created. For example, the created entity may include, without limitation, a compute instance at cloud service provider 160. In other words, using the domain-specific language described herein, instantiation of a variable may refer to, and cause to be created, a corresponding compute instance. In an implementation, the source code for program 152A may specify/define the cloud instance to which the variable is referenced or the cloud instance may be defined by a configurable parameter setting. Upon compilation, SIS 120 may store the variable, its reference, its state, how the compute instance may be used, and/or other state information using entity state information database 130.

Program 152B may also include the variable. When program 152B is compiled, an explain action can be executed in the run-time environment (explained in further detail below) that may query SIS 120 to determine whether the variable is in-scope to program 152B. Likewise, when program 152B is run, runtime environment 20 may query SIS 120 to determine whether the variable is in-scope as well as obtain current state information related to the variable.

In some instances, program 152B may cause the variable to be updated. For example, program 152B may cause a replacement compute instance to replace the existing compute instance at cloud service provider 160, causing an addressable identifier (e.g., an Internet Protocol address) to be changed to refer to the replacement computer instance. Responsive to such change, runtime environment 20 may provide SIS 120 with the update, which may update entity state information database 130 with the updated information for the variable. In another example, changes to instances of computing infrastructure (i.e., variables) initiated by an external actor (such as a user manually operating the cloud computing environment interface can be reverted back to its original form, it is found that the altered form does not conform to the original instance of the computing instance specified by the user through the domain specific programming language.

Program 152N may also include the variable. Variables from program 152N may be validated at compile and runtime, as described above. Program 152N, when executed, may obtain the current state information related to the variable. For instance, instead of a reference to a compute instance created by program 152A (which may have cause the compute instance to be created), a variable included in program 152N may reference the current compute instance, as updated by program 152B. In this manner, different programs may update the same variable, which may cause references for those variables to be updated as well. Using the domain-specific language described herein, different developers may therefore refer to different entities (such as compute instances at cloud service providers 160) natively within the language of the code.

FIG. 3 illustrates an exemplary run-time environment of a compiled domain-specific programming language for cloud services infrastructure, according to examples of the disclosure. As illustrated in FIG. 3, at the customer/client computer 300, a user can compose computer code using a domain-specific programming language that specifies computing infrastructure to implement on a cloud-based computing service.

Once a user has generated the code, the code is compiled at step 304, wherein it is converted from a user-friendly syntax generated by the user into an intermediate representation (illustrated at step 306) that can be understood by the command line interface of an infrastructure operating system. At step 308, the infrastructure operating system can execute the compiled code 306 by building and tracking what the code declares.

The code can then be sent to the interpreter and planner modules 310 that convert the command line interface language (i.e., intermediate representation 306) into a series of specific instructions that can executed by the infrastructure operating system. In one example the interpreter manager can use one or more planning modules to build the instructions. The interpreter manager can achieve this by employing a series of planning modules that accept, in some examples, resource tables at its input and generates resource tables in which any omissions in the syntax provided by the user are filled in. In one example, the planning modules can receive a resource table that specifies properties of the computing infrastructure to be built. The interpreter manager can review a resource table sent by the user (in the form of compiled domain specific code and send it to the series of planning modules based on what infrastructure needs have been declared by the user.

The planning modules alter the user's resource table and return it to the interpreter manager. This process may be repeated with other planning modules until the final correct version of the resource table is complete at step 312. The interpreter manager then converts the resource table into a machine instruction file which can be referred to as a low level declaration of the computer infrastructure to be built on the cloud. The low level declaration is then sent to the builder/driver 314 wherein the resource table is converted into a language that can be interfaced with the application program interface of a cloud provider 316.

As part of its operation, the interpreter and planner modules 310 can input the user declared instances of computing infrastructure, as well as the scope of those declared instances, generated by the user in the domain specific computing language. The interpreter can query an external state information service database (discussed above) to determine if the type of computing instance declared by the user exists, and if so, the state information service can provide any relevant state information to the interpreter.

Once the computing infrastructure has been built on the cloud computing environment, the implemented infrastructure can be “persisted” which means that the implemented infrastructure can be compared against the user's originally declared instance of the computing infrastructure as expressed in the domain-specific programming language. If any differences are found, the implementation of the computing infrastructure can be modified by the interpreter 310, so that the implementation of the infrastructure on the cloud matches the user's desired infrastructure.

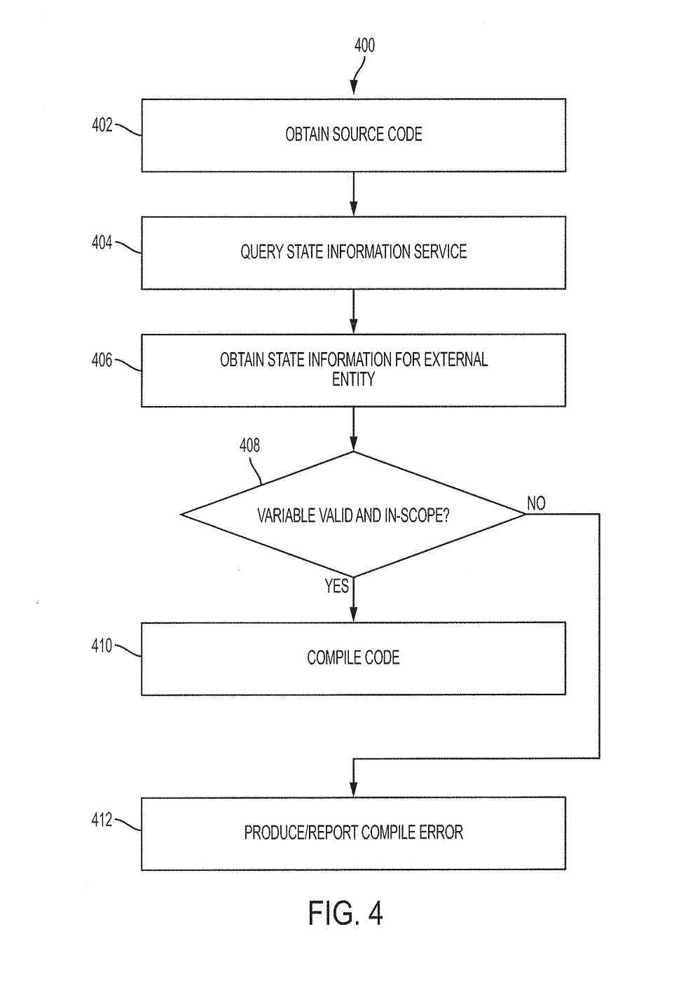

FIG. 4 illustrates a process 400 of compiling a domain-specific programming language for cloud services infrastructure, according to an implementation of the invention. The various processing operations and/or data flows depicted in FIG. 4 are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 402, source code in a domain-specific programming language may be obtained.

In an operation 404, a state information service may be queried to identify a variable in scope to the use in the language in order to determine if it exists, and, if so, whether it is in scope to reference. Operation 404 may be repeated, as necessary, for variables that appear in the source code. As discussed above, the state information service may be queried during an explain action (explained in detail below) in which an interpreter located in the run-time environment can query the state information service to determine if the variable exists, and if so, whether it is in scope to how it is referenced in the user generated code.

In an operation 406, state information: may be obtained based on the query.

In an operation 408, a determination of whether a variable exists and/or is in scope may be determined.

In an operation 410, responsive to a determination that the variable exists and is in scope, the source code may be transmitted to the run-time environment for implementation on the cloud service.

In an operation 412, responsive to a determination that the variable does not exist or is not in scope, a compile error may occur and be communicated.

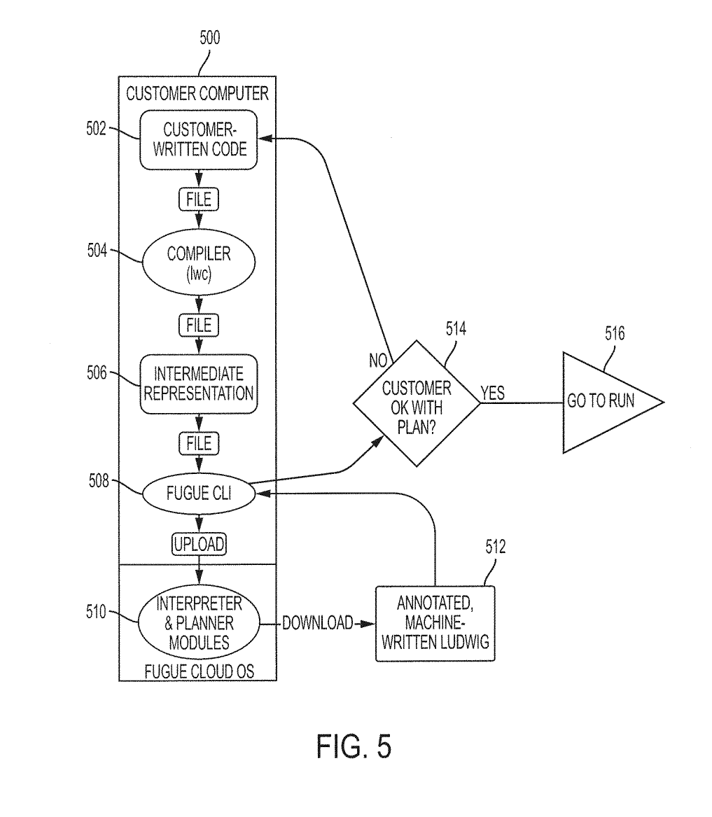

FIG. 5 illustrates an exemplary explain process according to examples of the disclosure. In the explain action illustrated in FIG. 5, steps 502, 504, 506, 508, and 510 operate in substantially the same way as their counterparts in FIG. 3 (i.e., steps 302, 304, 306, 308, and 310 respectively). However, in contrast to the process illustrated in FIG. 3, rather than converting the resource table generated by the interpreter into a machine instruction file, instead at step 512 the process returns the annotated resource table to the infrastructure operating system CLI 508.

As discussed above, as part of its operation, the interpreter can input the user declared instances of computing infrastructure, and query a state information service database to determine if they exist. If it is determined that the instance of computing infrastructure does not exist, then the state information service can indicate to the interpreter that the declared instance does not exist and the use can be notified at step 512.

If however all the declared variables exist, the user can be presented with a plan for how the infrastructure is to be implemented at step 514. At step 514 the user can determine if the received implementation plan is acceptable, and if so, the process can move to step 516 wherein the annotated coded produced at step 512 is converted into machine code that is compatible with the command line interface of a cloud computing services provider.

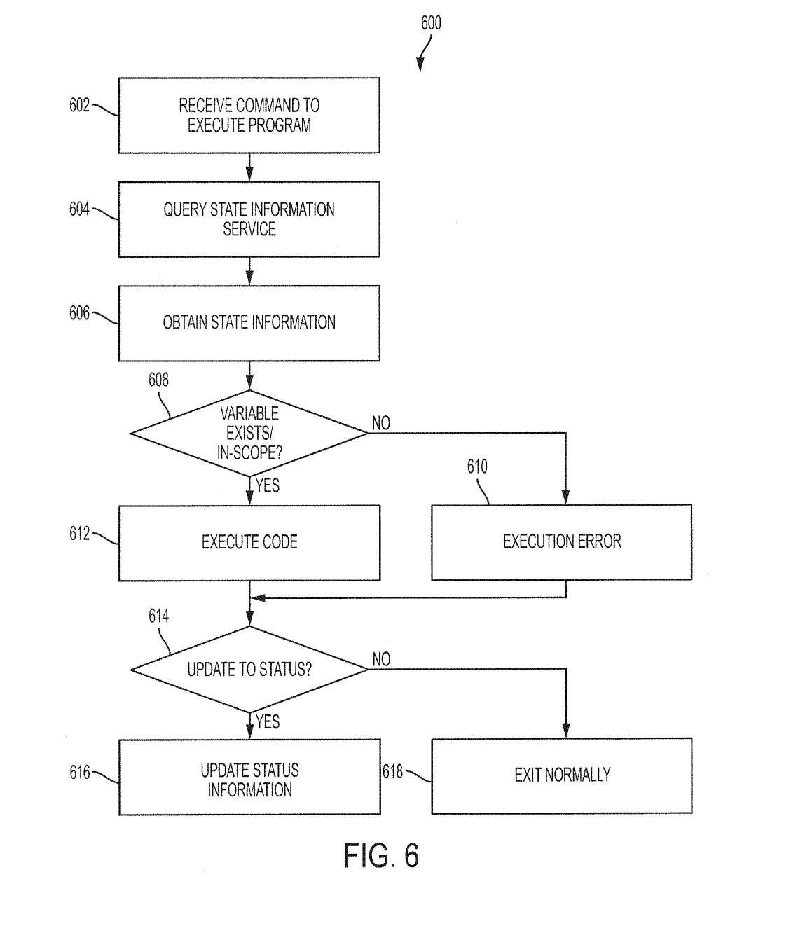

FIG. 6 illustrates a process 600 of executing a domain-specific programming language for cloud services infrastructure, according to an implementation of the invention. The various processing operations and/or data flows depicted in FIG. 6 are described in greater detail herein. The described operations may be accomplished using some or all of the system components described in detail above and, in some implementations, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 602, a command to execute a program compiled from source code using the domain-specific programming language may be received.

In an operation 604, a state information service may be queried to identify a variable in scope to the use in the language in order to determine if it exists, and, if so, whether it is in scope to reference. Operation 604 may be repeated, as necessary, for variables that appear in the source code.

In an operation 606, state information may be obtained based on the query.

In an operation 608, a determination of whether a variable exists and/or is in scope may be determined.

In an operation 610, responsive to a determination that the variable does not exist or is not in scope, a runtime error may occur and be communicated.

In an operation 612, responsive to a determination that the variable exists and is in scope, the program may be executed. Operation 612 may be repeated until all variables have been processed. In some implementations, execution of the code may cause a compute instance at a cloud service provider to be instantiated. In these implementations, state information (e.g., IP address, version, how used, etc.) may be stored via a state information service. In this manner, other programs that use the same variable may access the state information for the instantiated compute instance.

In an operation 614, a determination of whether an update to state information of an entity associated with a variable occurred during execution of the program may be made. For example, a program that uses a variable corresponding to a compute instance may have changed an IP address associated with the compute instance. Operation 614 may be repeated until all variables have been processed.

Responsive to a determination that an update occurred, in an operation 416, the state information may be updated via a state information service.

In an operation 618, code execution may terminate normally (e.g., without error conditions).

The domain-specific language described above can use one or more libraries to aid in the development of software. A library can include a collection of resources used by computer programs (such as those written in a domain-specific language) to allow for the development of software using the domain-specific language. Libraries can include configuration data, documentation, help data, message templates, pre-written code, subroutines, classes, values, type specifications.

Library code can be organized in such a way that it can be used by multiple programs that have no connection to one another. In other words, even if multiple users generate different programs using a coding language, by invoking a common library, each individual user-generated can use sub-routines and sub-programs that are contained within the library.

Therefore, in one example, a cloud computing infrastructure type can be invoked by a user-generated program, but the definition of that type can be stored in a library, so that any program which instantiates the type can use the code contained with the library to define the type.

The utility of libraries in a programming language can be utilized to enforce system policies on user-generated code developed in the domain-specific language. In one example, if a business or other enterprise wishes to ensure that computing infrastructure built on a cloud by the use of a domain-specific language complies with one or more policies of the enterprise with respect to computing infrastructure, they may utilize a validations library that when invoked will check the user-generated code to ensure that it complies with the desired policies. If the code does comply with the policies, then the code is allowed to compile and the computing infrastructure is built using the user-generated code. On the other hand, if the user-generated code does not comply with the enterprise's policies, the compiling of the code can be prevented and the user can be notified of the reason why the code was not allowed to be compiled.

In this way, the enterprise is able to allow for multiple individuals to build and maintain the enterprise's computing infrastructure via the cloud service provider, while at the same time ensuring that each and every instance of computing infrastructure built on behalf of the enterprise complies with the enterprise's self-defined policies.

A domain-specific language (and, by extension, a cloud operating system) can have the ability to add assertions to code that cause a compiler failure when the code it's related to does not meet its standards. That feature of the language can be known as Validations.

An administrator of the domain-specific language can write Validations and attach them to the Types affected with the keyword “validate,” in one example. Once the Types within the domain-specific language are attached, every time code written in the domain-specific language is compiled, it can check the user-generated code against the validations. This can happen locally on a domain-specific programming language author's desktop or on the cloud operating system, where validations are enforced against running infrastructure.

To illustrate the method of validation described above, an example is provided below. In the example, an enterprise wishes to enforce a policy wherein they desire to construct T types that only have the string “test” within them. Thus, when a user generates T types in the following manner:

type T:

### |T{value: String}

The code will only be compiled if the string value contains the string “test” within it. In order to enforce this policy, a Validation library can be employed wherein the validations are laid out within the library. For example, the code below can be an example module to write to the Validations Library that can be used to enforce the policy described above.

```
import Ludwig.Validation as .
check-t: fun(t):
  if String.equal(t.T.value, ″test″) then
    success
  else
    failure(″chedk-t failed″)
```

Wherein “Ludwig” can be a generic name for the domain-specific language, and wherein the function check-t can be the function within the Validations library that checks instantiations of the type T to determine if the policy of having them constructed only with the string “test” in them is followed.

The Validations library can then “register” the validations using the validate keyword: validate check-t. Once the validation has been registered, every time a T is constructed, the check-t validation function will be used to ensure that the instantiation of T contains the string “test” within it.

Another example is provided below. In the example below, the system administrator wishes to enforce a specific policy regarding the use of a type called “Apple.” First, the system administrator can create a Validation for the type “Apple” using the following code:

```
import Fugue.System.Apple as Apple
import Ludwig.Validation as Validation
fun noProcessesInTheFugueAccount(rule: Apple.Rule) -> Validation:
  case rule.(Apple.Rule).action of
    | Apple.AccountAction action ->
      if action == Apple.AccountRunProcess then
        let msg: ″The AccountRunProcess permission is not allowed
        in the fugue account.″
        case rule.(Apple.Rule).subject of
          | Apple.AccountType account -> case account of
            | Apple.AllAccounts -> Validation.failure(msg)
              | Apple.Account acct -> if acct.accountId == ″fugue-
12345678″ then
                  Validation.failure(msg)
                else
                  Validation.success
          |_ -> Validation.success
      else Validation.success
    |_  -> Validation.success
validate noProcessesInTheFugueAccount
```

In the above code, the system administrator can import a library called Fugue.System.Apple by inserting the line of code which reads as “import Fugue.System.Apple as Apple” which can include the definitions of the type Apple. The system administrator can also import the validations library by inserting the line of code which reads as “import Ludwig.Validation as Validation.” Then the system administrator can proceed to define the validation function for type “Apple” by defining a function called “noProcessesInTheFugueAccount” as shown above. Finally, the system can register the validation provided above to the type “Apple” by inserting the line of code which reads as “validate noProcessesInTheFugueAccount.”

Once the validation for the type “Apple” has been created by the system administrator, a user can use that validation to validate their own instantiations of the type Apple when generating their own code. An example of a user using the Apple validation is shown below:

```
import Fugue.System.Apple as Apple
import NoProcessesInFugueAccount
user1: Apple.User {userId: ″user1″}
fugueAccount: Apple.Account {accountId: ″fugue-12345678″}
devAccount: Apple.Account {accountId: ″dev-12345678″}
runProcessRule: Apple.accountRules {
  principals: [user1],
  accounts: [
    fugueAccount,
    devAccount,
  ],
  actions: Apple.allAccountActions,
}
```

In the example above, the user can import the library called Fugue.System.Apple by inserting the line of code which reads as “import Fugue.System.Apple as Apple” which can include the definitions of the type Apple. The system administrator can also import the NoProccesesInFugue libarary created by the system administrator as described above by inserting the line of code which reads as “import NoProcessesInFugueAccount.” Once the appropriate libraries have been imported the user can define their own code as shown in the example above.

The validations (as defined by the system administrator) on the type Apple can be run by using the compiler normally. In this example below, the compiler can be run from the user's laptop or desktop (i.e., the client machine).

```
$ lwc Apple.lw
ludwig (evaluation error):
  ″/opt/fugue/lib/Fugue/System/Apple.lw″ (line 81, column 39):
  error:
    81|  L.map(fun(t): case t of (p, a) -> Rule{principal: p, subject: AccountType(account),
action: AccountAction(a) }, L.cartesian-product(principals, actions))
\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }\hat{ }
  Failed validations:
    - The AccountRunProcess permission is not allowed in the fugue account. (from
NoProcessesInFugueAccount.noProcessesInTheFugueAccount)
  Stack trace:
    In call to fat ″/opt/fugue/lib/Ludwig/List.lw″ (line 133, column 32)
    In call to map at ″/opt/fugue/lib/Fugue/System/Apple.lw″ (line 81, column 5)
    In call to singleAccountRules at ″/opt/fugue/lib/Fugue/System/Apple.lw″ (line 77, column
38)
    In call to fat ″/opt/fugue/lib/Ludwig/List.lw″ (line 133, column 32)
    In call to map at ″/opt/fugue/lib/Fugue/System/Apple.lw″ (line 77, column 24)
    In call to accountRules at ″Apple.lw″ (line 9, column 17)
```

In this way, if the user's use of the type Apple is in compliance with the policy set by the system administrator in the validations library for the type Apple, then the user-generated code can compile normally. On the other hand, if the user' use of the of the type Apple is not in compliance with the policy set by the system administrator in the validations library for the type Apple, then the user-generated code may fail to compile, and the user will be notified of the compilation error.

As described above, the domain-specific programming language can also allow for a user to declare computing infrastructure strategies in addition to declarations of computing infrastructure. A declaration of computing infrastructure using a domain-specific language can request a specific component of computing infrastructure. The declaration can also specify the specific connections to the component as well as any properties of the component that need to be specified so that a cloud operating system can implement the desired component on a cloud service provider account. In contrast, a strategy rather than declaring a specific type of computing infrastructure would simply allow the user to define certain boundaries for the computing infrastructure that they wish to implement. The strategy by itself may not be enough information for a cloud operating system to go and create the computing infrastructure associated with fulfilling the strategy.

As an example, if use a user wanted to create an instance of computing infrastructure such as a load balancer, then the user using the domain specific programming language could declare the load balancer in code and provide any information associated with the load balancer (such as the specific type) that would enable a cloud-operating system to create the instance on the cloud service provider account. In contrast, a user could declare a strategy that instead of declaring a specific instance, could instead provide boundaries for the instance without declaring the specific instance. As an example, a user could declare a strategy that states that they want to implement the cheapest instances (in terms of monetary cost) of computing infrastructure that will produce no more than 300 milliseconds average latency. In this way, rather than declaring a specific computing instance, the user is declaring a goal. The goal in and of itself may not be enough information for a cloud operating system to create computing infrastructure. Instead, as described in detail below, the goal may have to be resolved by an AI engine to determine the specific instance or instances of computing infrastructure that need to be created to fulfill the goal.

The code example below represents and exemplary declaration of a strategy according to examples of the disclosure. The below strategy can be written by a user declaring desired computing infrastructure using a domain-specific programming language to declare a strategy rather than a specific computing instance. Using the example above, the below strategy can be created by a user that seeks to implement the cheapest instances of computing infrastructure that will produce no more than 300 milliseconds average latency.

```
# normal ASG
AutoScalingGroup
my-asg:
  AutoScaling.AutoScalingGroup.new {
    subnets: refuge-network.publicSubnets,
    minSize: 2,
    maxSize: 2,
    defaultCooldown: 300,
    healthCheckType: AutoScaling.Ec2,
    launchConfiguration: my-launch-configuration,
    terminationPolicies: [AutoScaling.ClosestToNextInstanceHour],
    enabledMetrics: [
      AutoScaling.GroupInServiceInstances,
      AutoScaling.GroupTotalInstances
    ],
    loadBalancers: [my-elb]
  }
# managed by Conductor
Strategy.AutoScaling.Aggressive
conductor-managed-asg:
    Strategy.AutoScaling.Aggressive.new {
        autoScalingGroup: my-asg,
        maxResponseTimeMs: 200
    }
# module Strategy.AutoScaling
type Aggressive:
    | Aggressive
        autoScalingGroup: AWS.AutoScalingGroup
        maxResponseTime: Optional<Int>
        ...
```

As discussed above, a strategy such as the one provided above may not provide enough specific information to allow a cloud operating system to convert the declaration into specific computing infrastructure, instead the cloud operating system in conjunction with an AI engine may need to resolve the strategy into a specific computing infrastructure instance at run-time. In other words, whereas a specific declaration of computing infrastructure in a domain-specific language code may represent a static declaration of code in which the specific computing instance to be generated is pre-ordained, the declaration of strategy can be resolved dynamically (i.e. at run-time) to create a specific instance of computing infrastructure that can fulfill the goal created and declared by the user.

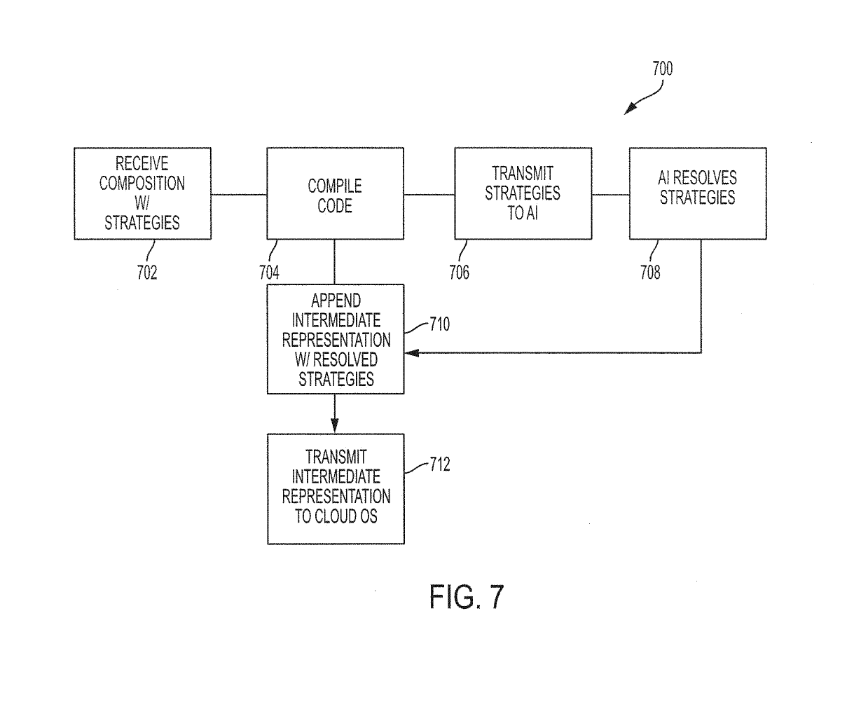

FIG. 7 illustrates an exemplary process for resolving user-declared strategies in a domain-specific programming language by an artificial intelligence engine so as determine and create computing infrastructure that fulfills the strategy according to examples of the disclosure. While the examples of FIG. 7 and other examples below refer to “artificial intelligence,” the disclosure should not be seen as limiting, and the examples below can also be implemented using other rules based engines, algorithms, or heuristics.

The process 700 can begin at step 702 wherein the compiler can receive a composition that includes both static declarations of computing infrastructure and user-declared strategies as described above. Once the code is received, the process can move to step 704 wherein the compiler can compile the received as described above. Also as described above, at step 704 the compiler can resolve the static declarations of computing infrastructure by generating an intermediate representation of the code. However, the compiler may not be able to resolve the strategy because the strategies contained within the code may need further resolving (i.e., they may need to be converted into static declarations). Thus at step 706, the compiler can transmit the strategies contained within the received code to an AI engine to be resolved.

At step 708, the AI engine can resolve the strategies to determine the specific declarations of computing infrastructure that can satisfy the user-declared strategy. Artificial intelligence can refer to a computing system that can perceive its environment and take actions that maximize its chance of success at some goal. In the context of computing infrastructure, an AI engine can receive the user-declared strategy and find an optimal solution to the desired strategy. In one or more examples, the AI engine can use real-time and historical data about the computing environment or computing environments in general in addition to the user defined strategy to develop a resolution to the strategy. As an example, an AI engine can use real-time data about the load and speed of a network to determine a resolution to the strategy declared by a user. In another example, an AI engine can use historical data about the performance of specific instances of computing infrastructure to help resolve a user-declared strategy.

In one or more examples, the AI engine can employ search and optimization techniques, logic programming, fuzzy logic, probabilistic methods, classifiers and statistical learning methods (i.e., machine learning), and neural networks to arrive at resolutions to the user-declared strategy.

Returning to the example of FIG. 7, once the AI engine has determined a solution the user-declared strategy (i.e., the AI engine has resolved the strategy), the AI engine can convert the determined resolution into an intermediate representation of static computer infrastructure similar to what is produced when user-declared static infrastructure is compiled at step 704. Once the AI engine has produced an intermediate representation of its determined resolution of the strategy, the process can move to step 710 wherein the determined intermediate representation is appended to the intermediate representation of the static user-declared computing infrastructure determined at step 704. Once the intermediate representation of the full code supplied by the user is generated, the process can move to step 712 wherein the complete intermediate representation can be sent to the cloud operating system to be implemented on a cloud service provider account as described above.

As discussed above, user-declared strategies can be resolved dynamically (i.e., at run-time) using not only the declaration of the strategy itself, but also real-time data and historical data regarding the computing infrastructure. Once the computing infrastructure has been implemented on the cloud service provider, the real-time and/or historical data may change meaning that the infrastructure currently implement on the cloud service provider account may no longer represent the optimal solution to the user-declared strategy provided in the domain-specific language code. Thus, in or more examples, the user-declared strategy may need to be “checked” to determine whether the solution generated by the AI engine still represents the optimal solution the user-declared strategy.

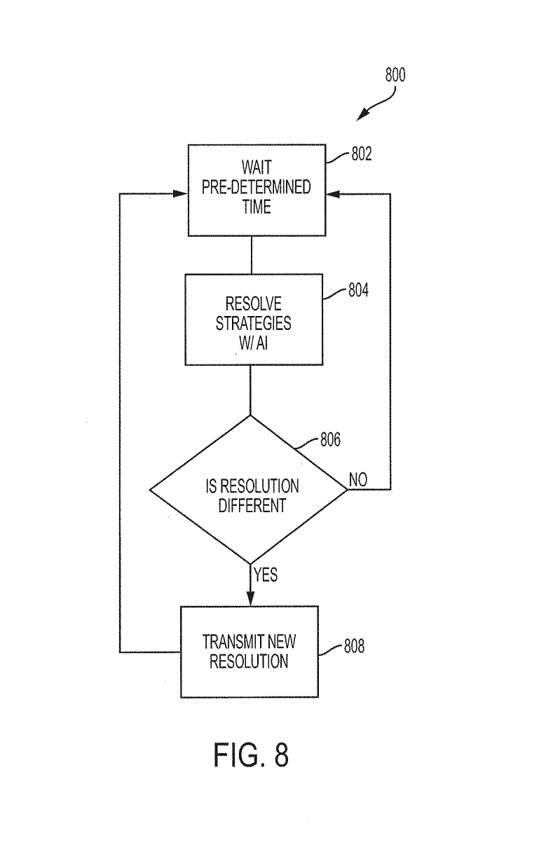

FIG. 8 illustrates an exemplary process of modifying computing infrastructure implemented on a cloud service provider account in response to changing resolutions of user-declared strategies in a domain-specific programming language according to examples of the disclosure. The process 800 can begin at step 802 wherein the process can wait a pre-determined amount of time after implementation of a resolution to a user-declared strategy on a cloud service provider account. A pre-determined amount of time can refer to an amount of time or it can also refer to a pre-determined number of computing cycles in one or examples of the disclosure.

Once the pre-determined amount of time has passed, the AI engine can repeat the process of taking the user-declared strategies and determining a resolution to those strategies at step 804. Generally, if the historical and/or real-time data associated with the strategy has not changed then the AI engine will likely determine a resolution to the strategy that is identical to the resolution of the strategy that was previously made. However, if the real-time and/or historical data has changed between the present time and when the resolution was originally determined, then the solution to the strategy determined by the AI engine may change. Thus, at step 806, the AI engine can compare the previous resolution of the strategy to the current resolution and determine if there are any differences between the two resolutions. If there are no differences, the process can go back to step 802 wherein the process again waits for another pre-determined amount of time to pass before repeating the process.

However, if at step 806 it is determined that there are differences between the current resolution of the strategy and the previous resolution, the process can move to step 808 wherein the new resolution is converted into an intermediate representation, and the new intermediate representation is transmitted to the cloud OS for implementation (i.e., the computing infrastructure on the cloud service provider account is modified according to the new determined resolution). Once the new resolution has been transmitted, the process can go back to step 802 wherein the process again waits for another pre-determined amount of time to pass before repeating the process.

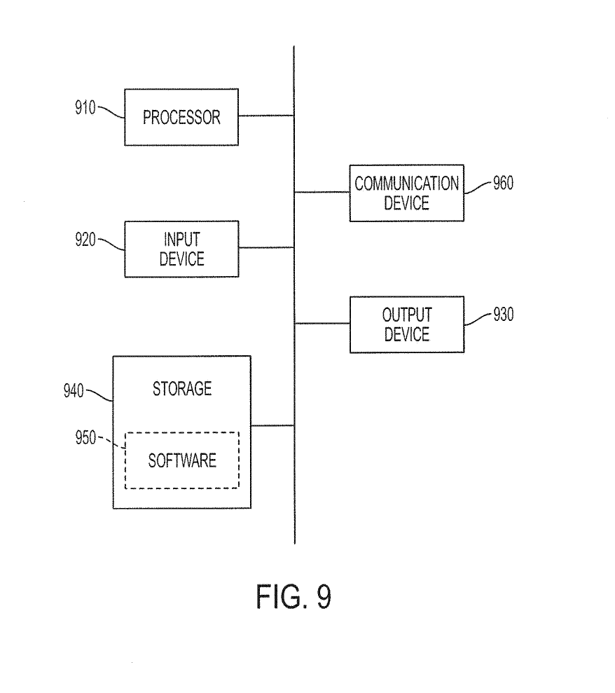

FIG. 9 illustrates an example of a computing device in accordance with one embodiment. Device 900 can be a host computer connected to a network. Device 900 can be a client computer or a server. As shown in FIG. 9, device 900 can be any suitable type of microprocessor-based device, such as a personal computer, workstation, server or handheld computing device (portable electronic device) such as a phone or tablet. The device can include, for example, one or more of processor 910, input device 920, output device 930, storage 940, and communication device 960. Input device 920 and output device 930 can generally correspond to those described above, and can either be connectable or integrated with the computer.

Input device 920 can be any suitable device that provides input, such as a touch screen, keyboard or keypad, mouse, or voice-recognition device. Output device 930 can be any suitable device that provides output, such as a touch screen, haptics device, or speaker.

Storage 940 can be any suitable device that provides storage, such as an electrical, magnetic or optical memory including a RAM, cache, hard drive, or removable storage disk. Communication device 960 can include any suitable device capable of transmitting and receiving signals over a network, such as a network interface chip or device. The components of the computer can be connected in any suitable manner, such as via a physical bus or wirelessly.

Software 950, which can be stored in storage 940 and executed by processor 910, can include, for example, the programming that embodies the functionality of the present disclosure (e.g., as embodied in the devices as described above).

Software 950 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 940, that can contain or store programming for use by or in connection with an instruction execution system, apparatus, or device.

Software 950 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate or transport programming for use by or in connection with an instruction execution system, apparatus, or device. The transport readable medium can include, but is not limited to, an electronic, magnetic, optical, electromagnetic or infrared wired or wireless propagation medium.

Device 900 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 900 can implement any operating system suitable for operating on the network. Software 950 can be written in any suitable programming language, such as C, C++, Java or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

What is claimed is:

1. A method for generating computing infrastructure on a cloud computing environment, the method comprising:
receiving source code written by a user written by a user in a domain-specific programming language, wherein the source code includes one or more variables that define one or more instances of computing infrastructure to be built on a cloud computing environment, and wherein the source code includes one or more strategies regarding the computing infrastructure to be generated on the cloud computing system;
converting the one or more variables into a first intermediate code;
transmitting the one or more strategies to an artificial intelligence engine, wherein the artificial intelligence engine is configured to:
receive the one or more strategies;
determine one or more resolutions to the one or more strategies, wherein the one or more resolutions are based on received one or more strategies; and
generate a second intermediate code based on the determined one or more resolutions;
receiving the generated second intermediate code from the artificial engine; and
converting the first intermediate code and the second intermediate code into one or more instructions readable by a command line interface of the cloud computing environment if the one or more instances of computing infrastructure.

2. The method of claim 1, wherein the artificial intelligence engine uses a statistical learning method to determine the one or more resolutions to the one or more strategies.

3. The method of claim 1, wherein the artificial engine uses historical data about the computing infrastructure to be built on the cloud computing environment to determine the one or more resolutions to the one or more strategies.

4. The method of claim 3, wherein the historical data can include data about a performance metric of the one or more instances of computing infrastructure to be built on a cloud computing environment.

5. A computing system for generating computing infrastructure on a cloud computing environment, the system comprising:
a memory;
one or more processors; and
one or more programs, wherein the one or more programs are stored in the memory and configured to be executed by the one or more processors, the one or more programs when executed by the one or more processors cause the processor to:
receive source code written by a user written by a user in a domain-specific programming language, wherein the source code includes one or more variables that define one or more instances of computing infrastructure to be built on a cloud computing environment, and wherein the source code includes one or more strategies regarding the computing infrastructure to be generated on the cloud computing system;
convert the one or more variables into a first intermediate code;
transmit the one or more strategies to an artificial intelligence engine, wherein the artificial intelligence engine is configured to:
receive the one or more strategies;
determine one or more resolutions to the one or more strategies, wherein the one or more resolutions are based on received one or more strategies; and
generate a second intermediate code based on the determined one or more resolutions;
receive the generated second intermediate code from the artificial engine; and
convert the first intermediate code and the second intermediate code into one or more instructions readable by a command line interface of the cloud computing environment if the one or more instances of computing infrastructure.

6. The system of claim 5, wherein the artificial intelligence engine uses a statistical learning method to determine the one or more resolutions to the one or more strategies.

7. The system of claim 5, wherein the artificial engine uses historical data about the computing infrastructure to be built on the cloud computing environment to determine the one or more resolutions to the one or more strategies.

8. The system of claim 7, wherein the historical data can include data about a performance metric of the one or more instances of computing infrastructure to be built on a cloud computing environment.

9. A non-transitory computer readable storage medium storing one or more programs, the one or more programs comprising instructions for generating computing infrastructure on a cloud computing environment, which when executed by a portable electronic device, cause the device to:
receive source code written by a user written by a user in a domain-specific programming language, wherein the source code includes one or more variables that define one or more instances of computing infrastructure to be built on a cloud computing environment, and wherein the source code includes one or more strategies regarding the computing infrastructure to be generated on the cloud computing system;
convert the one or more variables into a first intermediate code;
transmit the one or more strategies to an artificial intelligence engine, wherein the artificial intelligence engine is configured to:
receive the one or more strategies;
determine one or more resolutions to the one or more strategies, wherein the one or more resolutions are based on received one or more strategies; and
generate a second intermediate code based on the determined one or more resolutions;
receive the generated second intermediate code from the artificial engine; and
convert the first intermediate code and the second intermediate code into one or more instructions readable by a command line interface of the cloud computing environment if the one or more instances of computing infrastructure.

10. The non-transitory computer readable medium of claim 9, wherein the artificial intelligence engine uses a statistical learning method to determine the one or more resolutions to the one or more strategies.

11. The non-transitory computer readable medium of claim 9, wherein the artificial engine uses historical data about the computing infrastructure to be built on the cloud computing environment to determine the one or more resolutions to the one or more strategies.

12. The non-transitory computer readable medium of claim 11, wherein the historical data can include data about a performance metric of the one or more instances of computing infrastructure to be built on a cloud computing environment.

13. A method for generating computing infrastructure on a cloud computing environment, the method comprising:
receiving source code written by a user written by a user in a domain-specific programming language, wherein the source code includes one or more variables that define one or more instances of computing infrastructure to be built on a cloud computing environment, and wherein the source code includes one or more strategies regarding the computing infrastructure to be generated on the cloud computing system;
converting the one or more variables and the one or more strategies in the source into one or more instructions readable by a command line interface of the cloud computing environment, wherein converting the one or more strategies in the source code into one or more instructions readable by a command line interface of the cloud computing environment includes using an artificial intelligence engine to generate a first set of resolutions to the one or more strategies;
waiting a predetermined time after converting the one or more variables and the one or more strategies in the source into one or more instructions readable by a command line interface of the cloud computing environment;
reconverting the one or more strategies in the source code into one or more instructions readable by a command line interface of the cloud computing environment, wherein reconverting the one or more strategies includes:
using the artificial intelligence engine to generate a second set of resolutions to the one or more strategies;
comparing the first set of resolutions to the second set of resolutions and determining if there are differences between the first set and the second set; and
reconverting the one or more strategies in the source cord into one or more instructions readable by a command line interface of the cloud computing environment if it is determined that there are differences between the first set of resolutions and the second set of resolutions.

14. The method of claim 13, wherein the artificial intelligence engine uses a statistical learning method to determine the one or more resolutions to the one or more strategies.

15. The method of claim 13, wherein the artificial engine uses historical data about the computing infrastructure to be built on the cloud computing environment to determine the one or more resolutions to the one or more strategies.

16. The method of claim 15, wherein the historical data can include data about a performance metric of the one or more instances of computing infrastructure to be built on a cloud computing environment.

17. A computing system for generating computing infrastructure on a cloud computing environment, the system comprising:
a memory;
one or more processors; and
one or more programs, wherein the one or more programs are stored in the memory and configured to be executed by the one or more processors, the one or more programs when executed by the one or more processors cause the processor to:
receive source code written by a user written by a user in a domain-specific programming language, wherein the source code includes one or more variables that define one or more instances of computing infrastructure to be built on a cloud computing environment, and wherein the source code includes one or more strategies regarding the computing infrastructure to be generated on the cloud computing system;
convert the one or more variables and the one or more strategies in the source into one or more instructions readable by a command line interface of the cloud computing environment, wherein converting the one or more strategies in the source code into one or more instructions readable by a command line interface of the cloud computing environment includes using an artificial intelligence engine to generate a first set of resolutions to the one or more strategies;
wait a predetermined time after converting the one or more variables and the one or more strategies in the source into one or more instructions readable by a command line interface of the cloud computing environment;
reconvert the one or more strategies in the source code into one or more instructions readable by a command line interface of the cloud computing environment, wherein reconverting the one or more strategies includes:
using the artificial intelligence engine to generate a second set of resolutions to the one or more strategies;
comparing the first set of resolutions to the second set of resolutions and determining if there are differences between the first set and the second set; and
reconverting the one or more strategies in the source cord into one or more instructions readable by a command line interface of the cloud computing environment if it is determined that there are differences between the first set of resolutions and the second set of resolutions.

18. The system of claim 17, wherein the artificial intelligence engine uses a statistical learning method to determine the one or more resolutions to the one or more strategies.

19. The system of claim 17, wherein the artificial engine uses historical data about the computing infrastructure to be built on the cloud computing environment to determine the one or more resolutions to the one or more strategies.

20. The system of claim 19, wherein the historical data can include data about a performance metric of the one or more instances of computing infrastructure to be built on a cloud computing environment.

21. A non-transitory computer readable storage medium storing one or more programs, the one or more programs comprising instructions for generating computing infrastructure on a cloud computing environment, which when executed by a portable electronic device, cause the device to:
receive source code written by a user written by a user in a domain-specific programming language, wherein the source code includes one or more variables that define one or more instances of computing infrastructure to be built on a cloud computing environment, and wherein the source code includes one or more strategies regarding the computing infrastructure to be generated on the cloud computing system;
convert the one or more variables and the one or more strategies in the source into one or more instructions readable by a command line interface of the cloud computing environment, wherein converting the one or more strategies in the source code into one or more instructions readable by a command line interface of the cloud computing environment includes using an artificial intelligence engine to generate a first set of resolutions to the one or more strategies;
wait a predetermined time after converting the one or more variables and the one or more strategies in the source into one or more instructions readable by a command line interface of the cloud computing environment;
reconvert the one or more strategies in the source code into one or more instructions readable by a command line interface of the cloud computing environment, wherein reconverting the one or more strategies includes:
using the artificial intelligence engine to generate a second set of resolutions to the one or more strategies;
comparing the first set of resolutions to the second set of resolutions and determining if there are differences between the first set and the second set; and
reconverting the one or more strategies in the source cord into one or more instructions readable by a command line interface of the cloud computing environment if it is determined that there are differences between the first set of resolutions and the second set of resolutions.

22. The non-transitory computer readable medium of claim 21, wherein the artificial intelligence engine uses a statistical learning method to determine the one or more resolutions to the one or more strategies.

23. The non-transitory computer readable medium of claim 21, wherein the artificial engine uses historical data about the computing infrastructure to be built on the cloud computing environment to determine the one or more resolutions to the one or more strategies.

24. The non-transitory computer readable medium of claim 23, wherein the historical data can include data about a performance metric of the one or more instances of computing infrastructure to be built on a cloud computing environment.
